(19) United States
(12) Patent Application Publication
(10) Pub. No.: US 2004/0203896 A1
(43) Pub. Date: Oct. 14, 2004

(54) Proximity-based matching method and system

(76) Inventors: Yuri Deigin, Thornhill (CA); Eugene Doktorov, Toronto (CA)

Correspondence Address: BERESKIN AND PARR, SCOTIA PLAZA, 40 KING STREET WEST-SUITE 4000 BOX 401, TORONTO, ON, M5H 3Y2, CA

(21) Appl. No.: 10/320,439

(22) Filed: Dec. 17, 2002

(51) Int. Cl. H04Q 7/20; H04M 1/00; H04B 1/38

(52) U.S. Cl. 455/456.1; 455/556.1

(57) ABSTRACT

A method and system for providing matching services to a plurality of users. The method and system involves (a) generating a plurality of user profiles for the plurality of users, wherein for each user in the plurality of users, the plurality of user profiles includes an associated user profile including location information for the user; (b) for each user in the plurality of users, updating the location information for the user using a mobile communication device located close to the user; and, (c) for each user in at least some of the users in the plurality of users, providing a search capability for searching at least some of the plurality of profiles based on the location information of the user and the location information stored in the at least some of the plurality of profiles.

### FIELD OF THE INVENTION

The present invention relates to a matching method and system, and more specifically relates to a real-time proximity-based matching method and system.

### BACKGROUND OF THE INVENTION

Situations often arise in which it would be mutually advantageous for two people to meet, but they do not know of each other and thus are unable to meet. For example, one person may wish to retain another with particular skills—such as, say, a mechanic. A second person who is a suitably skilled mechanic may desire the work. However, if these people do not know of each other, then they will be unable to form a mutually beneficial relationship.

This situation also arises with respect to individuals having common interests. That is, individuals or groups may be looking for individuals interested in participating in certain activities—say, poker or hockey. This situation may also arise in relation to people seeking a personal relationship. Two people may be both highly compatible and interested in entering into a personal relationship. However, this will not happen as long as they are unaware of each other.

Prior art solutions to these problems include advertising as well as matching methods and systems. Through advertising, information can be provided about services being offered. Through personal advertisements, information can be provided regarding others who are seeking personal relationships of various sorts. By publishing a personal advertisement, one can advertise one's own availability. Advertising functions by providing information to potentially interested parties. These potentially interested parties can then contact each other if they so wish. Matching services go beyond advertisements, in that matching services actually make connections between different users.

In the present era of globalization, many people travel a great deal. Technologies have been devised to enable these travelers to stay in touch with their businesses, families, etc. These systems include cell phones and other mobile communication devices. However, it is more difficult for travelers to become familiar with the range of services being offered as well as personal opportunities in a geographical area in which they do not permanently reside. That is, reading advertisements requires a fair investment of time and effort, and may not be worth this investment if the stay in a particular area is likely to be of short duration. Similarly, matching services are not typically designed in a way that is useful for travelers. Thus, it is more difficult for travelers requiring certain services or looking for personal interaction with others to meet these needs/wants. This problem is exacerbated by the fact that these travelers are less familiar with their surroundings, and are thus less able to make the desired connections. That is, it may be easy for travelers to find people with whom to play poker when they are at home because they know many people there. However, this will be much more difficult when they are away from home and in unfamiliar social terrain.

Accordingly, a matching system and method that takes present location into account and provides information quickly is desirable.

### SUMMARY OF THE INVENTION

An object of one aspect of the present invention is to provide an improved method for providing matching services to a plurality of users.

In accordance with this first aspect of the present invention, there is provided a method of providing matching services to a plurality of users. The method comprises (a) generating a plurality of user profiles for the plurality of users, wherein for each user in the plurality of users, the plurality of user profiles includes an associated user profile including location information for the user; (b) for each user in the plurality of users, updating the location information for the user using a mobile communication device located close to the user; and, (c) for each user in at least some of the users in the plurality of users, providing a search capability for searching at least some of the plurality of profiles based on the location information of the user and the location information stored in the at least some of the plurality of profiles.

An object of a second aspect of the present invention is to provide an improved system for providing matching services to a plurality of users.

In accordance with this second aspect of the present invention, there is provided a system for providing matching services to a plurality of users. The system comprises (a) storage means for storing a plurality of profiles, each user in the plurality of users having an associated profile in the plurality of profiles, the associated profile comprising associated location information; (b) a plurality of communication means, each user having an associated communication means in the plurality of communication means for repeatedly transmitting an associated current location for each user to the storage means for storage, wherein the associated communication means for at least one user in the plurality of users comprises a search module for (i) transmitting a search request from the user, the search request including match criteria for searching at least one searchable profile in the plurality of profiles, the match criteria including the current location of the user, and (ii) providing search results to the user; and, (c) a search module for receiving the search request and for searching the at least one searchable profile in the plurality of profiles based on the search request to provide the search results.

### BRIEF DESCRIPTION OF THE DRAWINGS

A detailed description of the preferred embodiments is provided herein below with reference to the following drawings, in which:

FIG. 1, in a block diagram, illustrates a proximity-based matching system in accordance with a preferred embodiment of the invention;

FIG. 2, in a block diagram, illustrates a mobile communication device of the system of FIG. 1;

FIG. 3 in a schematic diagram, illustrates communication flows between two mobile communication devices and the server of FIG. 1 in accordance with the preferred embodiment of the invention;

FIG. 4, in a schematic diagram, illustrates communication flows between two mobile communication devices and the server of FIG. 1 in accordance with the preferred embodiment of the invention;

FIG. 5, in a schematic diagram, illustrates communication flows between a single mobile communication device and the server of FIG. 1 in accordance with an embodiment of the invention; and,

FIG. 6, in a schematic diagram, illustrates communication flows between two mobile communication devices and the server of FIG. 1.

### DETAILED DESCRIPTION OF THE PREFERRED EMBODIMENTS OF THE INVENTION

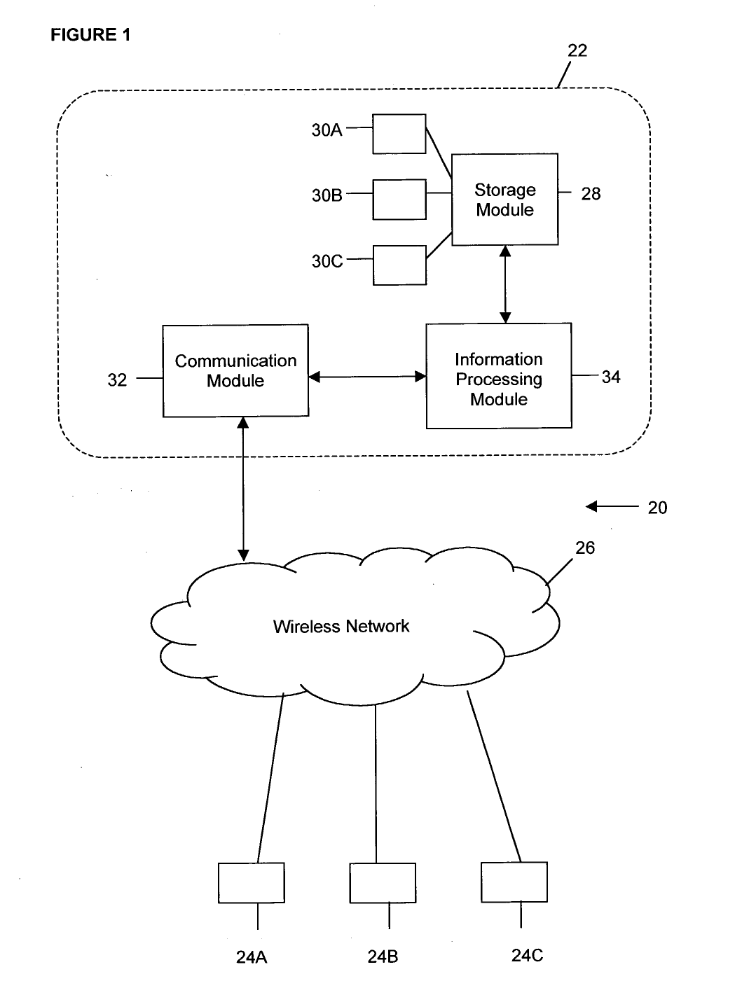

Referring to FIG. 1, there is illustrated in a block diagram a system 20 in accordance with an embodiment of the invention. This system 20 includes a server 22 and a plurality of mobile communication devices 24 provided to individual users. The mobile communication devices 24 communicate with the server 22 via a wireless network 26. The server 22 includes a storage module 28 for storing a plurality of profiles 30. The plurality of profiles 30 includes a profile for each of the users. That is, the system 20 of FIG. 1 includes mobile communication devices 24A, 24B and 24C, each of which is associated with a different user. For each of these users there is a corresponding profile in the plurality of profiles. Thus, profile 30A is the profile for the user having mobile communication device 24A, profile 30B is the profile for the user having mobile communication device 24B, and profile 30C is the profile for the user having mobile communication device 24C. The server also includes a communication module 32 for communicating with the mobile communication devices 24 via the wireless network 26 and an information processing module 34 for conducting searches of the profile stored in the storage module 28.

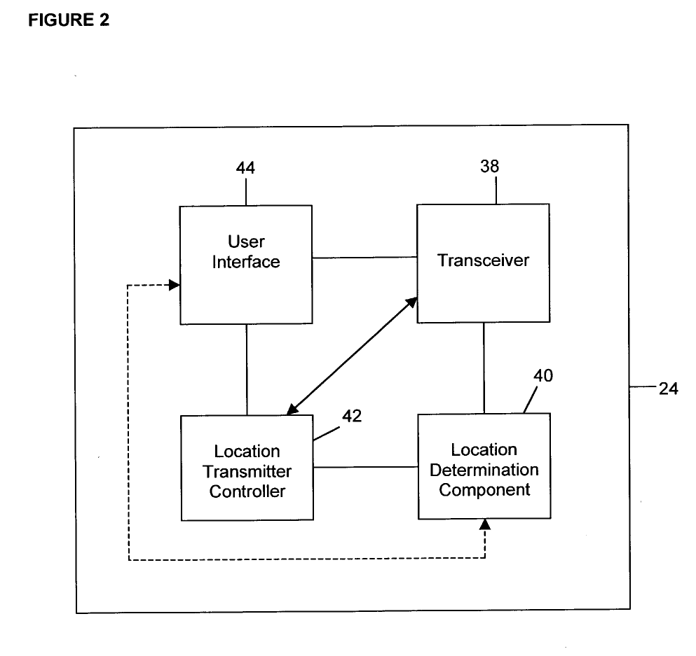

Referring to FIG. 2, each of the mobile communication devices 24 includes a wireless transceiver 38, together with a location determination component 40, a location transmitter controller 42, and a user interface 44.

The first step in the case of any individual user, will be to sign up the user for the service. This can be done directly via a website, e-mail, phone, postal service, etc., or via any third party such as a mobile network service provider, a dating service, a travel operator promotion, etc. Preferably, the user will be able to sign up for this service directly from a mobile communication device 24 they already have, and the system 20 will provide them with the means for inputting their personal information to build both their public profile and private profile.

During the signup process, or at any time after signup, users can create public and private profiles to be stored on the server. Public profiles are potentially visible to other users, while private profiles will only be accessible to the providers of the service.

Typically, users are categorized as being at least one of two categories. By being in category one, category one users indicate that they are willing to be contacted by other users. In contrast, category two users can contact category one users, but cannot, themselves, be contacted without first initiating communications. Any person can sign up to be both a category one and category two user simultaneously. In that case, such person will have the ability to contact users of category one and to be contacted by users of category two.

Once a user is signed up, and has a public profile and private profile stored in the storage module 28 of the server 22, the user's location information is periodically updated via the transceiver 38. Specifically, each mobile communication device 24 includes a location determination component 40. This location determination component 40 may automatically determine the location of the user by, for example, using a global positioning system. Then, a location transmitter controller 42 will instruct the transceiver 38 to transmit this information to the communication module 32 of the server 22 via the wireless network 26. This updating of the location may be continuous, or, alternatively, may happen whenever there is a material change in the location information of the user. From the communication module 32, this updated location information is communicated to the storage module 28 and from there is assigned to the correct profile 30, such that the profile 30 is updated to reflect the current location information of the user. Alternatively, the mobile communication device 24 may instead receive updates on geographical location from the user himself or herself and transmit this information to the server 22. This may be entirely at the user's initiative, or, alternatively, may be the result of prompting by the mobile communication device 24.

Also, the mobile communication device 24 should preferably provide a field for entering a desired geographical proximity. For example, some users may be interested in any other users that meet their search criteria that are within a distance of five miles, while other users may require a smaller radius of, say, one mile.

Preferably, the user is able to log off from the system, at which point, their profile will be removed from the profiles 30 available to be searched.

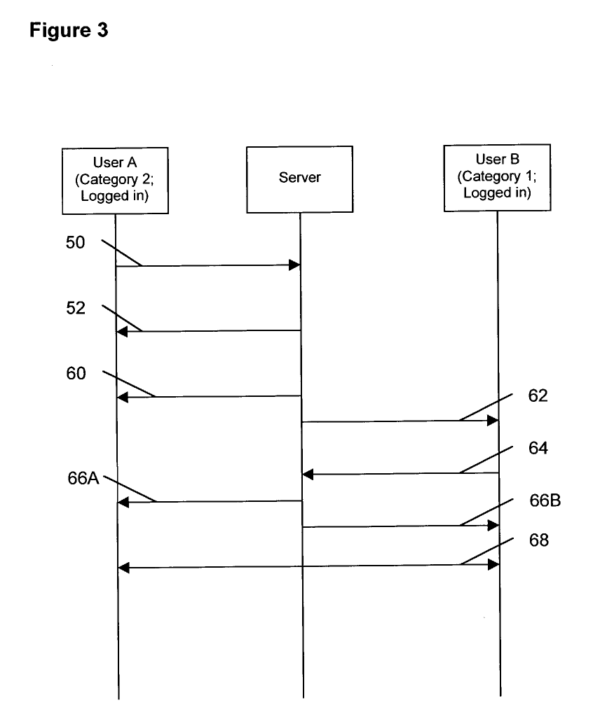

Referring to FIG. 3, there is illustrated in a schematic diagram, a series of communications between a server 22 and a user A, and between the server 22 and a user B. Both user A and user B communicate with the server 22 via their individual mobile communication devices 24. As a result of these communications, a communications channel is established between users A and B. To begin, user A enters search parameters for determining a list of users into the mobile communication device 24A. These search parameters are entered into the user interface 44 of the mobile communication device 24 belonging to user A. This list or search request is then sent to the communication module 32 of the server 22 via the wireless transceiver 38 of the mobile communication device and the wireless network 26 in communication 50.

The information processing module 34 then runs a search of the plurality of profiles 30 using the search request and determines that profiles 30 for users B and C, both of category one, meet the parameters in the search request. Accordingly, the public profiles of users B and C are communicated to the mobile communication device 24 belonging to the user A in communication 52. The user A is then free to review these search results. In communication 60, the user A sends a request to contact user B to the server. The information processing unit 34 then notifies user B via the communication module 32 and the mobile communication device 24 belonging to user B of this invitation from user A in communication 62. User B then reviews this invitation via the user interface 44 of the mobile communication device 24 belonging to user B and in communication 64 back to the server 22 accepts this invitation. Then, the information processing unit 34 provides contact information to both user A and B in communications 66A and 66B respectively to establish a direct communication channel 68 between users A and B.

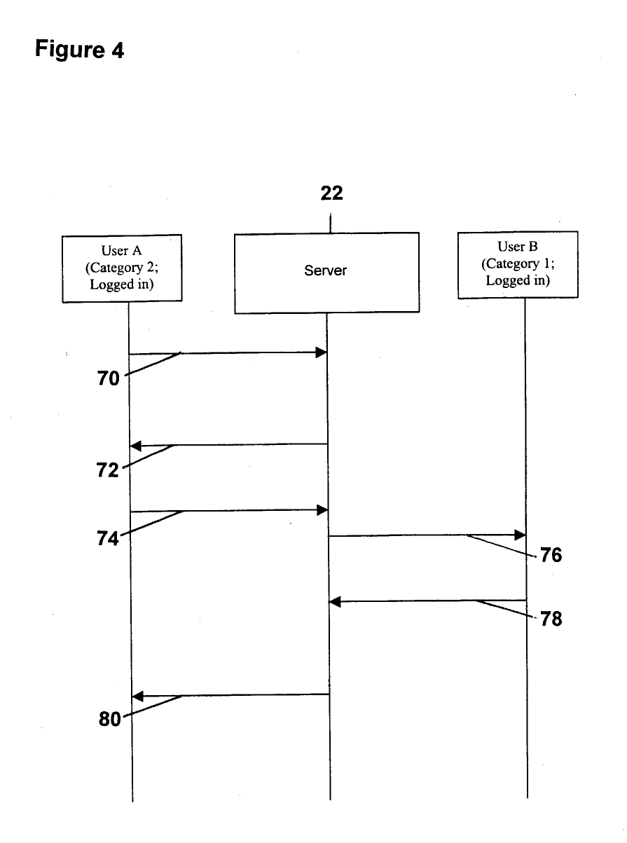

Referring to FIG. 4, there is illustrated in a schematic diagram, a series of communications between a user A and the server of FIG. 1, and between a user B and the server 22. Similar to the series of communications of FIG. 3, user A begins by entering into mobile communication device 24A search parameters for determining a list of users matching these parameters. These search parameters are entered into the user interface 44 of the mobile communication device 24. This list or search request is then sent to the communication module 32 of the server 22 via the wireless transceiver 38 of the mobile communication device 24 and the wireless network 26 in communication 70. The information processing module 34 of the server 22 then runs a search of all of the profiles 30 stored on the storage module 28 using the search parameters. The information processing module 34 determines that the profiles 30 for users B and C, both of category one, meet the parameters specified in the search request. Accordingly, the public profiles of users B and C are communicated to the mobile communication device 24 belonging to user A in communication 72. The user A then reviews these search results. In communication 74, the user A sends a request to the server 22 to contact user B. The information processing unit 34 of the server 22 then notifies user B of this invitation from user A in communication 76. Communication 76 is transmitted from the server 22 to user B via the communication module 32 and the mobile communication device 24 belonging to user B. Thus far these steps are the same as those executed in the series of communications of FIG. 3. However, unlike the situation in the series of communications of FIG. 3, user B does not accept the invitation. This may be a result of user B explicitly sending a decline communication 78 to the server 22, or, may be due simply to a failure on the part of user B to respond at all to the invitation from user A. The information processing unit 34 of the server 22 then sends communication 80 to user A. Communication 80 notifies user A that the contact request with user B has been unsuccessful.

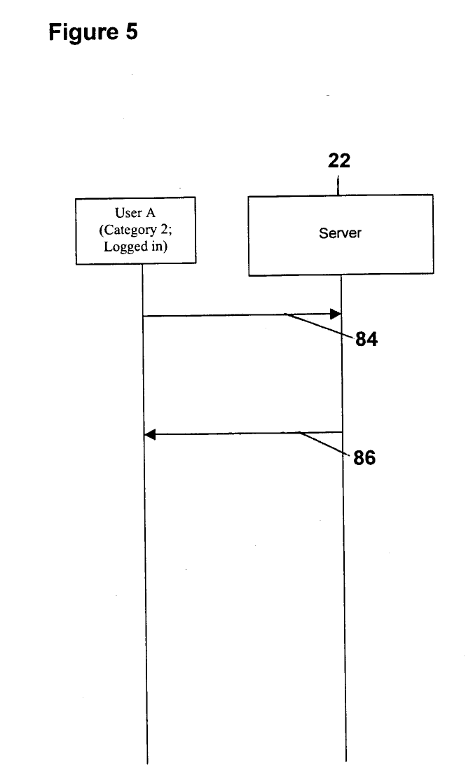

Referring to FIG. 5, there is illustrated in a schematic diagram, a series of communications between a user A and the server. Again, to begin, user A enters search parameters for determining a list of users matching these parameters into the user interface 44. This list or search request is then sent to the server 22 in communication 84. The information processing module 34 of the server 22 then runs a search of the plurality of profiles 30 using the search request. However, unlike the searches conducted in FIGS. 3 and 4, the search conducted by the server 22 in FIG. 5 returns no matches. The information processing unit 34 then sends a communication 86 to user A advising user A that there are no users of category one satisfying the search parameters entered by user A who are in close proximity to the position specified by user A. Preferably, user A or any other user of category two is able to modify the geographical area in which the search is being conducted. Thus, if the server 22 does not find a match within a given geographical area, user A may choose to expand the search to cover a wider area.

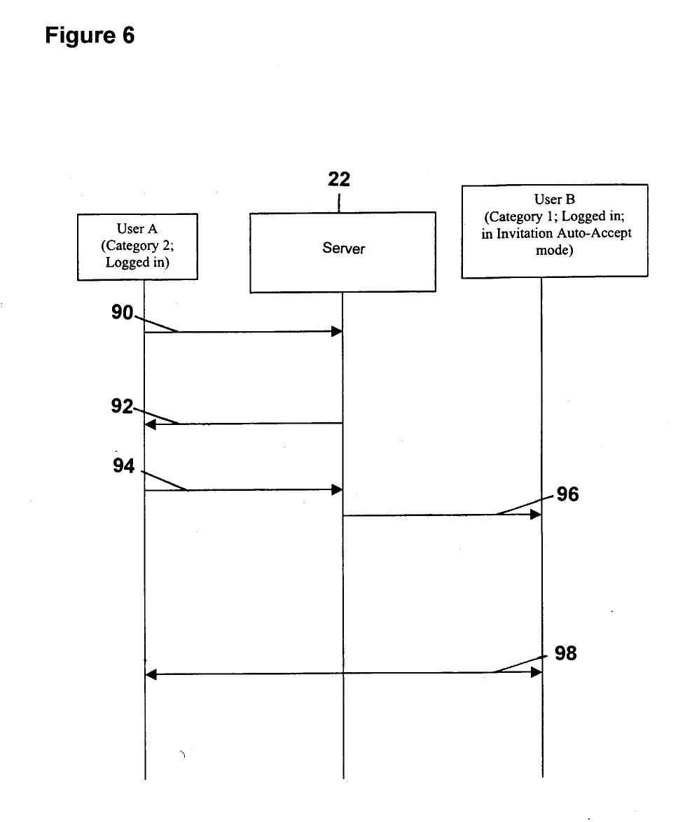

Referring to FIG. 6, there is illustrated in a schematic diagram a series of communications between users A and B and the server that ultimately result in establishing a communication link between users A and B. This series of communications is much the same as those of FIG. 3; however, user B is a category one user who is logged in in an invitation auto-accept mode. As a result, user B will respond to any invitation from any user.

To begin, user A enters search parameters for determining a list of users matching these parameters into the user interface 44. This list or search request is then transmitted to the server 22 in communication 90. The information processing module 34 of the server 22 then searches the plurality of profiles 30 stored on the storage module 28 and determines that user profiles 30 for users B and C match the search criteria. In communication 92, the public profiles 30 of users B and C are transmitted from the server 22 back to user A. User A then views this information and decides to contact user B. In communication 94, user A notifies the server 22 of the user's intention to contact user B. The information processing module 34 of the server 22 then notifies user B of this invitation from user A in communication 96. As user B is in invitation auto-accept mode, the server 22 does not wait for user B to accept the invitation, but immediately establishes a communication channel between users A and B in communication 98. This may be achieved by sending contact information to users A and B. Where, say, user A is in a new location, then the server 22 will require up-to-date contact information for user A. This may be straightforward, where A can simply be contacted through his or her mobile communication device 24. However, where this is not the case, the user interface 44 of the mobile communication device 24 includes a contact information field in which user A can enter contact information for sending to the server 22, which information the server 22 can then send to user B to enable user B to contact user A.

The foregoing description is expressed in very general terms, reflecting the fact that the present invention may be implemented in any number of different contexts. However, to give some idea of the range of contexts in which the above-described aspects of the invention can be implemented to advantage, these aspects of the invention will now be described with respect to particular contexts.

With respect to the aspect of the invention illustrated in the schematic diagram of FIG. 3, say that user A is in a new location for a short period of time, say a week. User A also knows that he will be returning to this location periodically over the next few months or so. He is interested in investigating possible relationships; however, avenues such as dating services and personal advertisements are not suitable for his situation as he is not permanently located in this location, and these services are not structured to reflect the fact that his location changes from time to time. The aspects of the present invention illustrated in FIG. 3 are, however, usefully applicable in his situation.

Due to the operation of the location determination component 40 and location transmitter controller 42 of the mobile communication device 24, the server 22 has up-to-date information regarding user A's location. User A then enters search criteria for suitable partners. These search criteria might well include the fact that he is not permanently situated in this location. Then, in communication 50, user A transmits these search parameters to the server 22. The information processing module 34 of the server 22 then searches the profiles 30 of the category one users stored on the storage module 28. These profiles 30 may be for other users who are also in this location only periodically and are also interested in relationships during those periods that they are in this location. Based on this search of the profiles 30 stored on the storage module 28, the information processing module 34 determines that users B and C meet the search criteria. In communication 52, the server communicates the public profiles of users B and C to user A. User A then reviews these public profiles 30 and in communication 60 to the server 22, requests that user B be contacted. The information processing unit 34 of the server then contacts user B in communication 62, notifying user B of the invitation from user A. In communication 64, user B accepts the invitation. Then, in communications 66A and 66B respectively, the server provides contact information to users A and B. Using this contact information, a communication channel 68 can be established between user A and user B. Alternatively, if user B was not interested in the invitation from user A, then, as in communication 78 of FIG. 4, user B could have declined the invitation from user A. Say, on the other hand, that no users of category one met user A's search criteria. Then, the situation would be represented in FIG. 5, in which communication 86 notifies user A of the unsuccessful search.

Alternatively, say that user A periodically requires translation assistance. Then, referring to FIG. 6, user A may first enter search parameters for translators having particular skills, and in communication 90 transmits this search request to the server 22. The information processing module 34 of the server 22 would then search the storage module 28 using these search parameters to look for users meeting the search parameters. The information processing module 34 determines that users B and C have the required translation skills, and communicates the public profiles 30 of these users to user A in communication 92. User A then reviews these profiles 30 and, in communication 94, requests that user B be contacted. In communication 96, the server 22 notifies user B of the invitation from user A. However, unlike the situation in FIG. 3, user B operates a business and has thus opted to be in an auto-accept mode in which all invitations for contact are automatically accepted. Thus, in communication 98, a communication channel is open between users A and B, without any additional steps being required by user B.

The invention may also be applied in other contexts. For example, if a traveler is an enthusiastic sports fan, chess player or wants to play sports after work, then the user can use the method and system of the present invention to try to contact other users having similar interests.

In these contexts, the communication flows would be similar to those described above, in which a traveler is looking for a relationship during the time in which he or she is in a particular location. In the present context, this relationship would focus on common interests.

Other variations and modifications of the invention are possible. For example, the foregoing examples have focused on personal or intimate or business relationships. However, communications for any purpose are possible. All such modifications or variations are believed to be within the sphere and scope of the invention as defined by the claims appended hereto.

1. A method of providing matching services to a plurality of users, the method comprising:
(a) generating a plurality of user profiles for the plurality of users, wherein for each user in the plurality of users, the plurality of user profiles includes an associated user profile including location information for the user;
(b) for each user in the plurality of users, updating the location information for the user using a mobile communication device located close to the user; and,
(c) for each user in at least some of the users in the plurality of users, providing a search capability for searching at least some of the plurality of profiles based on the location information of the user and the location information stored in the at least some of the plurality of profiles.

2. The method as defined in claim 1 wherein a plurality of mobile communication devices are distributed among the plurality of users such that for each user, the plurality of mobile communication devices includes an associated mobile communication device for the user.

3. The method as defined in claim 1 wherein step (b) comprises, for each user in the plurality of users, automatically updating the location information for the user using the associated mobile communication device.

4. The method as defined in claim 1 further comprising categorizing each user in the plurality of users as at least one of a first category and a second category; and wherein step (c) comprises, for each user in the plurality of users in the second category, providing a search capability for searching at least one profile for at least one user in the first category based on the location information of the user in the second category and the location information stored in the at least one profile for the at least one user in the first category.

5. The method as defined in claim 4 wherein each user in the plurality of users is categorizable as being in both the first category and the second category.

6. The method as defined in claim 4 further comprising providing each user in the plurality of users in the second category with the user profile for each user in the first category returned by searching in step (c).

7. The method as defined in claim 4 further comprising providing each user of the first category with a logoff option for removing the associated profile for the user of the first category from the plurality of profiles searched in step (c).

8. The method as defined in claim 1 wherein step (a) comprises, for each user in the plurality of users, providing a user input means to the user for input of personal information regarding the user to be included in the associated user profile.

9. The method as defined in claim 8 wherein the user input means comprises a contact information field for receiving contact information for the user.

10. The method as defined in claim 3 wherein the user input means comprises a geographical proximity field for specifying a required geographical proximity.

11. A system for providing matching services to a plurality of users, the system comprising:
(a) storage means for storing a plurality of profiles, each user in the plurality of users having an associated profile in the plurality of profiles, the associated profile comprising associated location information;
(b) a plurality of communication means, each user having an associated communication means in the plurality of communication means for repeatedly transmitting an associated current location for each user to the storage means for storage, wherein the associated communication means for at least one user in the plurality of users comprises a search module for
(i) transmitting a search request from the user, the search request including match criteria for searching at least one searchable profile in the plurality of profiles, the match criteria including the current location of the user, and
(ii) providing search results to the user; and,
(c) a search module for receiving the search request and for searching the at least one searchable profile in the plurality of profiles based on the search request to provide the search results.

12. The system as defined in claim 11 wherein for each user in the plurality of users, the associated communication means is an associated mobile communication device.

13. The system as defined in claim 12 wherein the associated mobile communication device for each user comprises a location determination component for determining the current location of the user.

14. The system as defined in claim 13 further comprising a position determination unit for repeatedly and automatically obtaining the associated current location of each user from the associated mobile communication device, the associated mobile communication device for each user being operable to transmit the associated current location for the user to the position determination unit.

15. The system as defined in claim 14 wherein the position determination unit is operable to repeatedly and automatically request the associated current location of each user from the associated mobile communication device.

16. The system as defined in claim 13 wherein the associated mobile communication device for each user comprises a location transmission controller for repeatedly and automatically transmitting the associated current location of the user to the storage means for storage.

17. The system as defined in claim 15 wherein the location determination component determines the current location of the user by using a global positioning system.

18. The system as defined in claim 11 further comprising categorization means associated with the storage means for categorizing each user in the plurality of users as at least one of a first category and a second category; wherein
the at least one searchable profile includes the associated profile for each user categorized as the first category, and
for each user categorized as the second category, the associated communication means comprises a search module.

19. The system as defined in claim 18 wherein each user in the plurality of users can be categorized as being in both the first category and the second category.

20. The system as defined in claim 18 wherein the search results include contact information for each user of the first category returned by searching in step (c).
